(19) United States
(12) Patent Application Publication
(10) Pub. No.: US 2008/0197958 A1
(43) Pub. Date: Aug. 21, 2008

(54) Coil Body with Integrated Magnet Core Mounting

(75) Inventor: Ekkehard Bielass, Dresden (DE)

Correspondence Address: SUGHRUE MION, PLLC, 2100 PENNSYLVANIA AVENUE, N.W., SUITE 800, WASHINGTON, DC, 20037, US

(73) Assignee: A. KAYSER AUTOMOTIVE SYSTEMS GMBH, Einbeck (DE)

(21) Appl. No.: 11/813,326

(22) PCT Filed: Jan. 9, 2006
(86) PCT No.: PCT/EP2006/000103

§ 371 Date: Mar. 28, 2008

(30) Foreign Application Priority Data
Jan. 7, 2005 (DE) 10 2005 000 985.9

(51) Int. Cl. H01F 27/02; H01F 41/00

(52) U.S. Cl. 336/92; 29/602.1

(57) ABSTRACT

The invention relates to a coil housing device, in particular, for a solenoid valve, comprising a coil body (2) and a rest or support element (4), integrally embodied with the coil body (2). The coil body (2) and the support element (4) have an essentially hollow cylindrical embodiment, for housing a magnet core (6), whereby the support element (4) is at least provided in the region of the magnet core (6) to be housed and the coil body (2) forms the inner surface (8) of the coil housing device, at least in the region of the magnet core (6) to be housed.

The present invention relates to a coil housing device, in particular for a solenoid valve, and to a method for producing a coil housing device, also in particular for a solenoid valve.

Coil housing devices of this type are typically wound with a copper wire and essentially function according to the principle of an electromagnet. Such a typical coil housing device according to the prior art is illustrated in FIG. 1. The coil housing device comprises a coil body 102, which is implemented from a plastic. A bearing bush 104, in which a magnetic core 106 may move axially, is inserted into this coil body 102. The bearing bush 104 has a friction coating 108 on the surface facing toward the magnetic core 106, to allow frictionless movement of the magnetic core 106 as much as possible.

However, a coil housing device of this type has the disadvantage that the system made of coil body and bearing bush occupies a relatively large wall thickness, because of which the housing space for wire turns to be wound around the coil body is restricted. In addition, it is problematic to use such a coil housing device in an aggressive environment, because the carrier material (typically iron) of the bearing bush is not resistant, so that the conduction of the magnetic field is reduced.

It is therefore the object of the present invention to provide a coil housing device, in particular for a solenoid valve, and a method for producing a coil housing device, in particular for a solenoid valve, in which the coil housing device is implemented compactly, so that a high number of turns may be provided around the coil housing device, and use is possible in an aggressive environment without impairing the performance of the system.

This object is achieved by a coil housing device, in particular for a solenoid valve, having the features of claim 1, and by a method for producing a coil housing device, in particular for a solenoid valve, having the features of claim 12. Preferred embodiments are the subject matter of the dependent subclaims.

According to the present invention, a coil housing device, in particular for a solenoid valve, is provided, comprising a coil body and a support or carrier element, which is implemented integrally with the coil body, the coil body and the carrier material being implemented as essentially hollow-cylindrical, to accommodate a magnetic core, the carrier element at least being provided in the area of the magnetic core to be accommodated, and the coil body forming the internal surface of the coil housing device at least in the area of the magnetic core to be accommodated. By implementing the carrier element integrally in or with the coil body, an advantageously compact construction of the coil housing device may be provided. “Integrally” is to be understood for this purpose in particular to mean that the carrier element and the coil body are essentially implemented in one piece. However, carrier element and coil body may be implemented from different materials. Therefore, the carrier element is essentially connected unremovably to the coil body. The unit made of coil body and carrier element is implemented as essentially hollow-cylindrical to accommodate a magnetic core. “Hollow-cylindrical” in this context means any cross-sectional shape, for example, elliptical, polygonal, or similar shapes. However, the unit made of coil body and carrier element is preferably implemented as a hollow cylinder which has an essentially circular or annular cross-section. The internal configuration of the unit made of coil body and carrier element is essentially tailored to the external configuration of the magnetic core to be accommodated. The carrier element is advantageously provided at least in the area of the magnetic core to be accommodated. In other words, the carrier element essentially encloses or envelops the accommodated magnetic core. Because the magnetic core may move axially along a longitudinal axis in the coil housing device, it is advantageous to design the carrier element in such a way that it is provided at least in the area in which the magnetic core to be accommodated may move. The coil body advantageously forms the internal surface of the coil housing device at least in the area of the magnetic core to be accommodated. In other words, a contact of the magnetic core with the carrier element is therefore advantageously not possible. The internal surface of the coil body thus advantageously forms a slide face, on which the magnetic core may slide. Because the coil body is advantageously stabilized by the carrier element, it is preferably possible to implement the coil body from a relatively soft plastic having good sliding and/or bearing properties.

The coil body more preferably encloses or surrounds the carrier element, so that the coil body forms the internal surface and the external surface of the coil housing device. In the event of a cylindrical implementation of the coil body and the carrier element, the carrier element may essentially be implemented as a hollow cylinder embedded in the coil body. The coil body may thus have a radial groove, for example, which extends along the coil body over the area in which a carrier element is to be provided. The carrier element may be inserted into this groove, so that carrier element and coil body are implemented integrally. Alternatively, however, the coil housing device may be produced using a casting method, in which the carrier element is laid in the casting mold and has the coil body cast around it.

Furthermore, the hollow-cylindrical carrier element preferably has multiple recesses or openings distributed around the circumference. The carrier element may thus advantageously have recesses which are provided as depressions or setbacks on the lateral surface (internal and/or external), without the wall of the carrier element being completely broken through. Additionally or alternatively, however, openings distributed around the circumference may also be provided, which extend through the entire wall thickness of the carrier element. Openings of this type may be provided by holes, for example. The geometrical configuration of the recesses or openings is selectable arbitrarily. Thus, for example, essentially circular drilled holes or setbacks may be provided. Alternative geometrical implementations, such as oblong slots or other polygonal shapes, are also possible, however. In addition, a mixture of recesses or openings configured in various geometries may be provided, for example, a preferably alternating mixture of holes and slots.

The coil body advantageously extends through the openings of the carrier element. This is particularly advantageous if the coil housing device is produced in a casting method, in which the carrier element provided with openings is inserted into the injection molding tool or the mold. During the injection molding process, the coil body is molded around the carrier element, the material of the coil body being able to penetrate through the openings of the carrier element and thus filling up the space of the openings.

In a further preferred embodiment, the internal surface of the coil body has a coefficient of friction less than 0.6, preferably less than 0.1, in the area of the magnetic core to be accommodated. It is therefore advantageously possible for the magnetic core to slide easily in the coil housing device because of the low friction resistance, which is determined by the low coefficient of friction. This advantageous sliding property may be provided by selecting a material having especially low friction resistance for the coil body. Additionally or alternatively, the coil body may also be appropriately coated on its internal surface. Improved functionality is thus provided in the event of use as a solenoid valve.

The coil body and the carrier element are preferably implemented as essentially circular-cylindrical.

Furthermore, the carrier element is preferably implemented from a soft-magnetic material, preferably iron. The coil body is advantageously implemented from a preferably castable and/or temperature-resistant plastic, such as polyamide, polyethylene, or polypropylene.

In a further preferred embodiment, the coil housing device also has a cage or a sheath, which is designed to essentially cover the coil body at least peripherally. The cage or the sheath is advantageously implemented from a soft-magnetic material, preferably iron, so that a closed magnetic circuit results around the exterior of the coil.

The sheath is more preferably implemented as essentially cylindrical and has at least one front-side cover element and a mantle element. The cover element is advantageously implemented to essentially cover a front side of the coil body. The mantle element is implemented to cover the coil body (which is provided with a wire winding) peripherally.

The mantle element advantageously has at least one projection, which is designed to engage in a corresponding recess or opening in the cover element after being bent over or deformed. Cover element and mantle element are thus advantageously securely connected to one another.

Therefore, a cage or a sheath may be provided, in particular for an arbitrarily implemented coil housing device for a solenoid valve, comprising

a mantle element which is implemented as essentially hollow-cylindrical, and a cover element which is preferably implemented as essentially plate-shaped and has at least one recess or opening,

the mantle element having at least one essentially axially projecting projection or pin, which is implemented to engage externally in recesses or openings of the cover element by displacement by essentially approximately 180°. It is obvious that the mantle element does not have to cover the entire lateral surface of a coil housing device, but rather may be implemented solely by one or more tabs extending essentially perpendicularly from a floor element, which essentially span a hollow cylinder.

Of course, the cage or the sheath may have all of the features and advantages of the sheath of the coil housing device according to the present invention.

Furthermore, a method for producing a coil housing device, in particular for a solenoid valve, is provided according to the present invention, comprising the following steps:
providing an essentially hollow-cylindrical support or carrier element; and
integrally situating the carrier element in or on a coil body by molding the coil body around the carrier element, so that the coil body forms the internal surface of the coil housing device at least in the area of a magnetic core to be accommodated.

Therefore, a coil housing device is advantageously provided which may be implemented compactly, because the wall thickness of the coil body may be reduced, because the carrier element unfolds a stabilizing effect.

It is obvious that the further advantages and features described above with reference to the coil housing device according to the present invention may also be the subject matter of the method according to the present invention.

Further advantages and features of the present invention are explained on the basis of the following exemplary description of preferred embodiments with reference to the attached drawing.

FIG. 1 shows a sectional view of a coil housing device according to the prior art.

FIG. 2 shows a sectional view of an embodiment of the coil housing device according to the present invention.

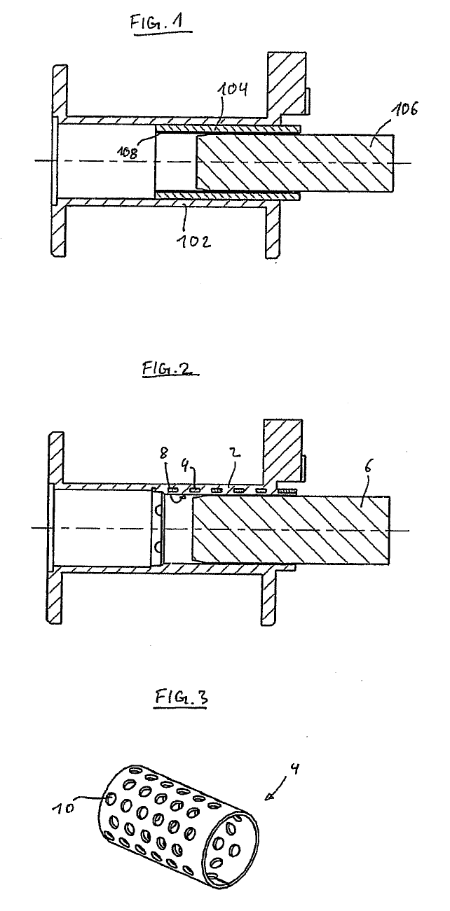

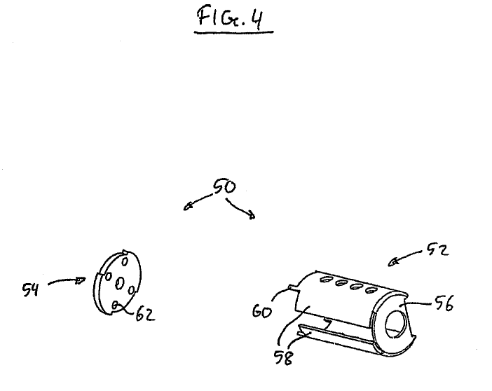

FIG. 3 shows a perspective view of a carrier element according to an embodiment of the coil housing device according to the present invention.

FIG. 4 shows a perspective view of a sheath, in particular for the coil housing device according to the present invention.

FIG. 1 shows a typical construction of a known coil housing device. The coil housing device has a coil body 102 made of plastic, in which a bearing bush 104 for mounting a magnetic core 106 is provided. The bearing bush 104 has a friction coating 108 on the internal surface facing toward the magnetic core 106. These typical coil housing devices have a relatively large wall thickness, because of which the winding space for a wire winding to be wound on the coil body 102 is restricted.

In the coil housing device according to the present invention shown in FIG. 2, this is not the case. The coil housing device has a coil body 2 and a carrier element 4. The coil body 2 and the carrier element 4 are implemented as essentially hollow-cylindrical to accommodate a magnetic core 6. In the embodiment illustrated, the carrier element 4 is essentially completely enclosed by the coil body 2. In particular, the coil body 2 forms the internal surface 8 of the coil housing device at least in the area of the magnetic core 6 to be accommodated.

The internal surface 8 advantageously has a low coefficient of friction at least in the area of the magnetic core 6 to be accommodated. The coefficient of friction is preferably less than 0.6 and especially preferably less than 0.1 in relation to the material of the magnetic core 6 to be accommodated. As a result, a friction influence on the movement of the magnetic core 6 which is as slight as possible is advantageously ensured. This property of the internal surface 8 may be provided on one hand, for example, by a suitable material selection of the coil body 2. Alternatively, however, the internal surface 8 may also be provided with a coating.

In the embodiment illustrated, coil body 2 and carrier element 4 are implemented as essentially hollow circular cylinders. However, any other arbitrary cross-sectional shape is also possible, for example, an ellipse or a polygonal cross-sectional shape, the magnetic core 6 being implemented as essentially corresponding in its cross-section.

The coil body 2 is preferably manufactured from a castable plastic. Plastics of this type are, for example, polyamide, polyethylene, or polypropylene.

The carrier element 4 is explained in greater detail with reference to FIG. 3. In a preferred embodiment, the carrier element 4 has multiple recesses or openings 10 distributed around the circumference. These may preferably extend through the wall of the carrier element 4, so that they are implemented as openings 10. Additionally or alternatively, however, only recesses may be provided, which do not extend completely through the wall of the carrier element 4, but rather only act as a setback. The geometrical configuration of the recesses or openings 10 is not restricted to the circular shape shown here, but rather may have any other arbitrary shape, for example, polygonal or the shape of an oblong slot. The carrier element is advantageously implemented from a soft-magnetic material, preferably iron. This causes an advantageous conduction of the magnetic field and thus improved effectiveness of the magnetic system. In addition, the carrier element 4 allows a stabilization of the coil body 2, so that a relatively soft material having good bearing or sliding properties may be provided for the coil body 2.

During the production of the coil housing device, the carrier element 4 provided with recesses or openings 10 is advantageously inserted into an injection molding tool or a mold. The plastic material of the coil body 2 is then added, so that it lies around the carrier element 4 and penetrates through the openings 10 of the carrier element 4. As a result, the carrier element 4 is essentially completely enclosed in the coil body 2.

In an especially preferred embodiment, the distance of the carrier element 4 to the internal surface 8 is very slight (i.e., the wall thickness of this area of the coil body 2 is comparatively small), so that the magnetic field is attenuated as little as possible. In this way, a low material expansion or swelling is also ensured, because the material of the coil body 2 may only slightly expand or constrict under the effect of aggressive media, in particular in the internal area of the coil body, because of the carrier element 4.

A sheath or a cage 50 is illustrated in FIG. 4, which is designed to essentially cover the coil body 2 or an arbitrary typical coil housing device or coil body peripherally at least in the area of its winding. The sheath 50 has a mantle element 52 and a cover element 54 in the embodiment shown. The mantle element comprises a floor element 56 and multiple tabs 58 extending perpendicularly therefrom. The floor element 56 is formed essentially as a plate-shaped element, its outline constituting the cross-sectional configuration of the cylindrical mantle element 52. Multiple tabs 58 extend originating from the floor element 56, to thus implement the hollow-cylindrical mantle element 52, which accommodates the coil body 2 provided with the wire winding. At least one projection or pin 60, which is designed to engage in the cover element 54, extends (essentially axially) from the tab 58.

The cover element 54 has at least one opening or recess 62. The number of openings 62 advantageously corresponds to the number of projections 60. The coil body 2 is inserted or plugged into the mantle element 52. The cover element 54 is then situated on the still open front side of the mantle element 52, the tabs 58 advantageously being pressed solidly against the circumference of the cover element 54. The projections 60 are then displaced over the cover element 54 and pressed externally into the opening 62. As a result, the projection 60 is essentially displaced by approximately 180°, so that it may engage externally in openings 62 of the cover element 54.

It is especially advantageous for this purpose if the internal cross-section of the mantle element 52 is somewhat larger in the area of the open front side than the external diameter of the cover element 54, so that easy positioning of the cover element 54 on the mantle element 52 may be ensured.

A tight contact of the mantle element 52 and cover element 54 on the coil body 2 provided with the winding is advantageously achieved by the mounting procedure described above, so that the finished mounted magnet system only has small gaps. Extraordinarily small losses for the magnetic circuit thus result.

### LIST OF REFERENCE NUMERALS

2 coil body
4 carrier element
6 magnetic core
8 internal surface
10 recess or opening
50 sheath
52 mantle element
54 cover element
56 floor element
58 tab
60 projection
62 opening
102 coil body
104 bearing bush
106 magnetic core
108 friction coating

1. A coil housing device, in particular for a solenoid valve, comprising a coil body and
a support or carrier element, which is implemented integrally with the coil body,
wherein the coil body and the carrier element are implemented as essentially hollow-cylindrical, to accommodate a magnetic core,
the carrier element is provided at least in the area of the magnetic core to be accommodated, and
the coil body forms the internal surface of the coil housing device at least in the area of the magnetic core to be accommodated.

2. The coil housing device according to claim 1, wherein the coil body encloses or surrounds the carrier element, so that the coil body forms the internal surface and the external surface of the coil housing device.

3. The coil housing device according to claim 1, wherein the hollow-cylindrical carrier element has multiple recesses or openings distributed around the circumference.

4. The coil housing device according to claim 3, wherein the coil body extends through the openings of the carrier element.

5. The coil housing device according to claim 1, wherein the internal surface has a coefficient of friction less than 0.6, preferably less than 0.1 at least in the area of the magnetic core to be accommodated.

6. The coil housing device according to claim 1, wherein the coil body and the carrier element are implemented as essentially circularly-cylindrical.

7. The coil housing device according to claim 1, wherein the carrier element is implemented from a soft-magnetic material, preferably iron.

8. The coil housing device according to claim 1, wherein the coil body His implemented from a preferably castable plastic, such as polyamide, polyethylene, or polypropylene.

9. The coil housing device according to claim 1, also having a cage or a sheath, which is designed to essentially cover the coil body at least peripherally.

10. The coil housing device according to claim 9, wherein the sheath is implemented as essentially cylindrical and has a front-side cover element and a mantle element.

11. The coil housing device according to claim 10, wherein the mantle element has at least one projection, which is designed to engage in a corresponding recess or opening in the cover element after it is bent over or deformed.

12. A method for producing a coil housing device, in particular for a solenoid valve, comprising the following steps:
providing an essentially hollow-cylindrical support or carrier element; and
integrally situating the carrier element in or on a coil body by molding the coil body around the carrier element, so that the coil body forms the internal surface of the coil housing device at least in the area of a magnetic core to be accommodated.
